(19) United States
(12) Patent Application Publication
(10) Pub. No.: US 2015/0152368 A1
(43) Pub. Date: Jun. 4, 2015

(54) Novel Shape for a Solid-Structure Consumable Good and Method for Extending Useful Life of Same

(71) Applicant: Michael William Murphy, Bellingham, WA (US)

(72) Inventor: Michael William Murphy, Bellingham, WA (US)

(21) Appl. No.: 14/093,451

(22) Filed: Nov. 30, 2013

(51) Int. Cl. C11D 17/04; C11D 11/00; C11D 9/00

(52) U.S. Cl. CPC C11D 17/04; C11D 9/00; C11D 11/00

(57) ABSTRACT

A method and apparatus for extending the useful life of a solid structure consumable good. In accordance with one embodiment of the invention, a bar of soap includes a slot or pocket in the body formed such that a remnant sliver of a substantially used bar of soap can be substantially inserted into the first slot or pocket. In a further embodiment, the slot or pocket has a shape substantially similar to a shape of the sliver such that the sliver can be inserted into the slot or pocket and thereafter be substantially wedged within the slot or pocket without falling out during use of the bar of soap. In yet a further embodiment, the unused bar has two slots or pockets, one on each end of the bar, such that one-half of a remnant bar may be inserted in each slot or pocket.

This application claims the benefit of U.S. Provisional Application No. 61/797,160, filed Nov. 30, 2012.

### BACKGROUND

1. Technical Field

This description generally relates to the field of consumable goods and, more particularly, to consumable goods having a solid structure that becomes consumed with use.

2. Description of the Related Art

Consumable goods, by their nature, dissipate through use. For many consumable goods, the consumable includes an effective component that gives the consumable its utility. When that specific component becomes degraded or depleted, then the consumable is rendered useless.

For some consumable goods, the effective component also gives the consumable its structure and defines the size and shape of the consumable good. In this case, as the good becomes consumed, not only is the effective component depleted but the size and shape of the consumable is also degraded or depleted compared with the consumable in its original form. If in its original form, the consumable's size and shape was optimized to provide maximum utility, then the consumable's utility may also be depleted over the course of its consumption. In some cases, the consumable's form may become depleted to such extent that the consumable's utility is effectively eliminated before the effective component is entirely consumed. In that case, the useful life of the consumable good is cut short and whatever effective component remains gets wasted.

An example of one such consumable good is bar soap. Bar soap is a consumable because the bar's effective component (the soap material) becomes depleted over the bar's life. Furthermore, the soap material also provides the bar its structure and defines the size and shape of the bar soap. Bar soap is also an example of a consumable good whose utility declines through use because as the size of the bar decreases through use, the utility of the bar for washing degrades. Furthermore, bar soap is an example of a consumable that loses its utility ahead of complete depletion of its effective component; once the bar falls below a certain size, its effectiveness at washing is virtually eliminated even though some of the effective component still remains. In that case, as with many solid-structure consumable goods, the useful life of the bar is cut short and any effective component still remaining ends up wasted.

### BRIEF SUMMARY

The present invention provides a method and apparatus for extending the useful life of a solid structure consumable good.

The present invention discloses a consumable good, such as a bar of soap, that includes (1) a body having a solid structure, and (2) a first slot or pocket in the body shaped such that a remnant sliver of a substantially used bar of soap can be substantially inserted into the first slot or pocket.

In accordance with a further embodiment, the slot or pocket in the body is shaped such that the remnant sliver becomes wedged within the bar of soap upon insertion into the slot or pocket.

In accordance with a further embodiment, the slot or pocket is shaped to facilitate melding between the remnant sliver and the bar of soap upon insertion of the sliver.

In accordance with a further embodiment, the slot or pocket has a shape substantially similar to a shape of the sliver to an extent such that the silver can be manually inserted into the slot or pocket and thereafter be substantially wedged within the slot or pocket without falling out during use of the bar of soap.

In accordance with a further embodiment, the slot or pocket has a shape that is one of the following: substantially cylindrical, substantially of an elliptical cylinder, substantially of a prism, substantially of a triangular prism, substantially of a rectangular prism, substantially of a section of a tri-axial ellipsoid defined by a cross-section of the tri-axial ellipsoid, substantially of a section of a tri-axial ellipsoid defined by a bisection of the tri-axial ellipsoid substantially along an axis of the tri-axial ellipsoid.

In accordance with a further embodiment, the tri-axial ellipsoid is substantially the shape and size of the sliver.

In accordance with a further embodiment, the ratio of the slot or pocket's depth to its narrowest breadth is greater than 0.2.

In accordance with a further embodiment, the ratio of the slot or pocket's depth to its narrowest breadth is greater than 1.0.

In accordance with a further embodiment, the slot or pocket extends all the way through the body.

In accordance with a further embodiment, the slot or pocket has traction features formed on at least a portion of an interior surface of the slot or pocket.

In accordance with a further embodiment, the slot or pocket has ridges along at least a portion of an interior surface of the slot or pocket

In accordance with a further embodiment, the ridges run at least one of: lengthwise along the slot or pocket, diagonally along the interior surface of the slot or pocket, and widthwise along the interior surface of the slot or pocket.

In accordance with a further embodiment, the bar of soap also includes a second slot or pocket in the body shaped such that portions of the remnant sliver of a substantially used bar of soap can be substantially inserted into each of the first and second slot or pocket.

In accordance with a further embodiment, the first and second slots or pockets are at opposite ends of the bar of soap.

In accordance with a further embodiment, the first slot or pocket has a shape substantially similar to a shape of a first portion of the sliver and wherein the second slot or pocket has a shape substantially similar to a shape of a second portion of the sliver.

In accordance with a further embodiment, the first and second slots or pockets each have a shape that is one of the following: substantially cylindrical, substantially of an elliptical cylinder, substantially of a prism, substantially of a triangular prism, substantially of a rectangular prism, substantially of a section of a tri-axial ellipsoid defined by a cross-section of the tri-axial ellipsoid, substantially of a section of a tri-axial ellipsoid defined by a bisection of the tri-axial ellipsoid substantially along an axis of the tri-axial ellipsoid.

In accordance with a further embodiment, the tri-axial ellipsoid is substantially the shape and size of half of the sliver.

In accordance with a further embodiment, the bar has at least one of: a curved shape, one or more curved surfaces, a shape substantially of a prism, and a shape substantially of a polyhedron.

In accordance with a further embodiment, a user exposes at least one of an unused bar of soap and a remnant sliver of a substantially used bar of soap to water and inserts the remnant sliver into a slot or pocket in the unused bar.

In accordance with a further embodiment, the user deforms a portion of the remnant sliver that extends outside the slot or pocket, such that the deformed portion of the remnant sliver fills an unoccupied space within the slot or pocket of the unused bar.

In accordance with a further embodiment, the user smears onto a surface of the unused bar a portion of the remnant sliver that extends outside the slot or pocket, such that the extended portion of the remnant sliver becomes more flush with the surface of the unused bar.

In accordance with a further embodiment, the user first separates the remnant sliver into halves and inserts each remnant half into a separate slot or pocket in the unused bar.

### BRIEF DESCRIPTION OF THE SEVERAL VIEWS OF THE DRAWINGS

FIGS. 1-5 each illustrate various perspective views of different solid-structure consumable goods in accordance with various different example embodiments.

FIGS. 6A and 6B illustrate various perspective views of different solid-structure consumable goods in accordance with various different example embodiments.

FIG. 7 illustrates in perspective view another solid-structure consumable good in accordance with a different example embodiment.

FIGS. 8A-8D illustrate in perspective view steps of a method for extending the useful life of a solid-structure consumable good using structures of a solid-structure consumable good in accordance with one embodiment of the invention.

FIGS. 9A-9D illustrate in perspective view steps of another method for extending the useful life of a solid-structure consumable good using structures of a solid-structure consumable good in accordance with one embodiment of the invention.

FIGS. 10A-10D illustrate in perspective view steps of yet another method for extending the useful life of a solid-structure consumable good using structures of a solid-structure consumable good in accordance with one embodiment of the invention.

### DETAILED DESCRIPTION

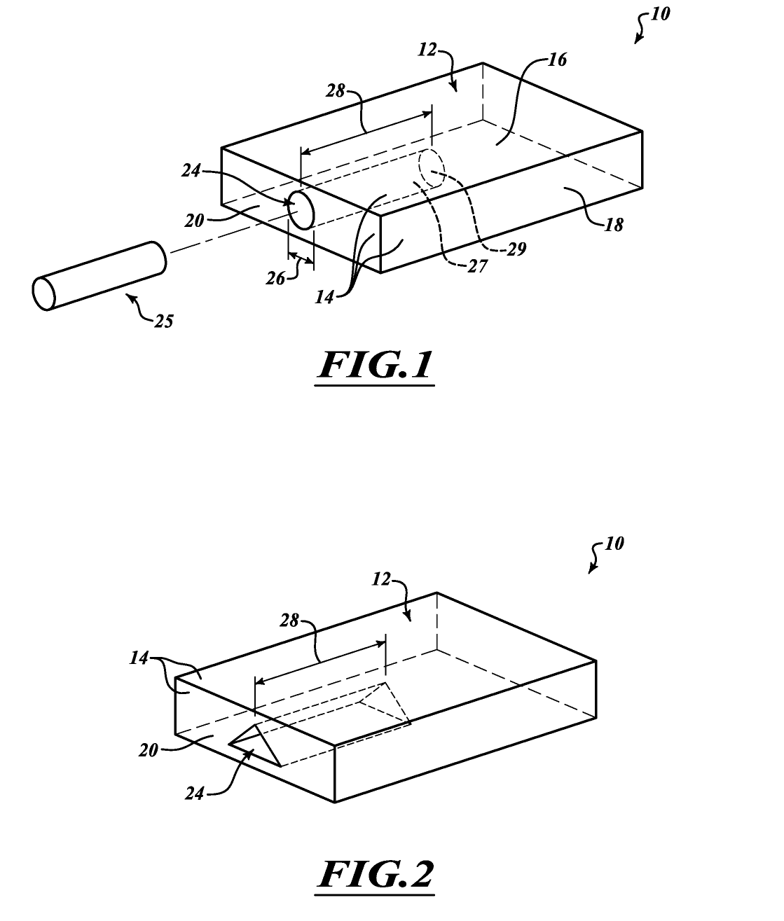

FIG. 1 shows a solid-structure consumable good 10 with a novel shape in accordance with one example embodiment.

The consumable good 10 includes a body 12 having an exterior surface 14. In one embodiment, the body 12 is composed of an effective component that gives the consumable good 10 its utility and its structure.

The exterior surface 14 of the body 12 has at least one major face 16 and may have additional faces. In the embodiment of FIG. 1, the exterior surface 14 includes a major face 16, a minor face 18, and an end face 20. The faces 16, 18, 20 may be orthogonal to one another as in the embodiment of FIG. 1, but in alternative embodiments the faces may be at angles to one another other than 90 degrees and/or curved.

The consumable good 10 includes within its body 12 a longitudinal cavity 24. The longitudinal cavity 24 intersects the exterior surface 14 through one of its faces and extends into the interior of the body 12. In the embodiment of FIG. 1, the longitudinal cavity 24 intersects the exterior surface 14 through the end face 20. However in alternative embodiments the longitudinal cavity 24 intersects the exterior surface 14 through the major face 16, the minor face 18, or an unidentified face.

The longitudinal cavity 24 provides a receptacle within the body 12 of the consumable good 10 where a remnant of a depleted consumable good 25 could be inserted. In use, the remnant consumable good 25 may be consumed simultaneously with the consumption of the consumable good 10 that holds it. By the time the holding consumable good 10 reaches a size where its utility is lost, the remnant good 25 is entirely consumed, therefore none of the effective material from the remnant good 25 goes to waste.

The longitudinal cavity 24 has a lateral dimension 26 and a longitudinal dimension 28. The lateral dimension 26 lies parallel to the exterior surface 14 intersected by the cavity 24 and quantifies the distance across (the breadth of) the cavity 24. The longitudinal dimension 28 lies perpendicular to the exterior surface 14 intersected by the cavity 24 and quantifies the cavity's depth.

In an example embodiment, the length of the longitudinal dimension 28 exceeds the length of the lateral dimension 26. In other words, the aspect ratio of the cavity 24 (depth relative to breadth) is greater than one. In still a further embodiment, the aspect ratio of the cavity 24 is greater than three, thereby increasing the ratio between the area of the cavity wall 27 and the cavity floor 29. Because the degree to which the two goods 10, 25 grip one another is directly proportional to the area of contact between them, the greater the aspect area, the more securely the remnant 25 is held within the cavity 24. Therefore as the aspect ratio (longitudinal dimension compared with lateral dimension) of the cavity increases, the likelihood of the two goods 10, 25 becoming re-separated decreases. In still a further embodiment, the cavity's aspect ratio is optimized so that the remnant consumable good 25 can be pushed into the cavity 24 without too much resistance, but once lodged within the cavity 24 the remnant good 25 stays there and does not easily fall out.

In the embodiment of FIG. 1, the longitudinal cavity 24 is cylindrical in shape. However in alternative embodiments the shape of the longitudinal cavity 24 may be any three-dimensional geometry. In an example embodiment, the longitudinal cavity 24 is longitudinal in shape, meaning the shape of the longitudinal cavity 24 at its intersection with the exterior surface 14 is the same at any point along the length of the longitudinal dimension 28. In an alternative embodiment, the longitudinal cavity 24 is tapered in shape, meaning the lateral dimension 26 continuously decreases in length at successive points along the longitudinal dimension 28 moving toward the interior of the body 12.

FIG. 2 shows a solid-structure consumable good 10 with a novel shape in accordance with one example embodiment. The longitudinal cavity 24 intersects the exterior surface 14 of the body 12 at its end face 20. In the embodiment of FIG. 2, the longitudinal cavity 24 is triangular in shape at its intersection with the end face 20 and maintains this shape for the entire length of the longitudinal dimension 28.

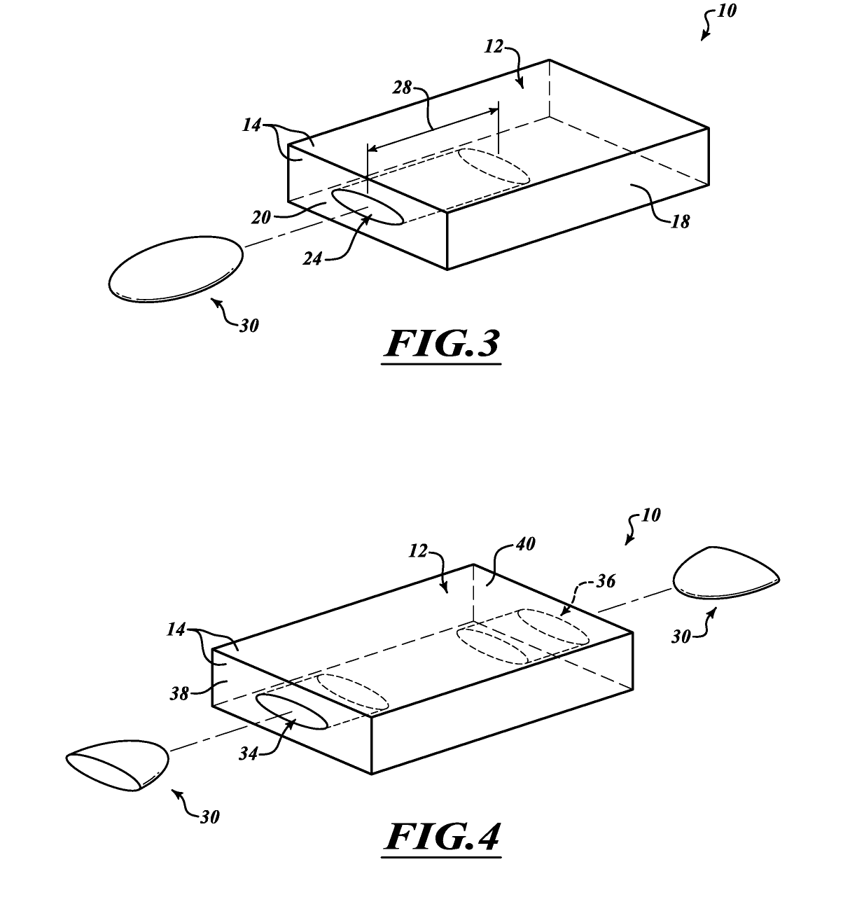

FIG. 3 shows a solid-structure consumable good 10 with a novel shape in accordance with one example embodiment. The longitudinal cavity 24 intersects the exterior surface 14 of the body 12 at its end face 20. The longitudinal cavity 24 is elliptical in shape at its intersection with the end face 20 and maintains this shape for the entire length of the longitudinal dimension 28. In an example embodiment, the shape of the longitudinal cavity 24 approximately matches the cross-sectional area of a remnant solid-structure consumable good 30 at its thickest point, so that the remnant good 30 could be received by the longitudinal cavity 24.

FIG. 4 shows a solid-structure consumable good 10 with a novel shape in accordance with one example embodiment. The consumable good 10 includes a pair of longitudinal cavities 34, 36 that intersect the exterior surface 14 of the body 12 at each end face 38, 40. In an example embodiment, each longitudinal cavity 34, 36 is elliptical in shape at its intersection with its corresponding end face 38, 40 so that each cavity 34, 36 approximately matches the cross-sectional area of the remnant solid-structure consumable good 30 at its thickest point. In still a further embodiment, the depth of each cavity 34, 36 is half the length of the remnant solid-structure consumable good 30, so that the remnant solid-structure consumer good 30 could be severed approximately in half and each cavity 34, 36 could receive one half of the severed good 30.

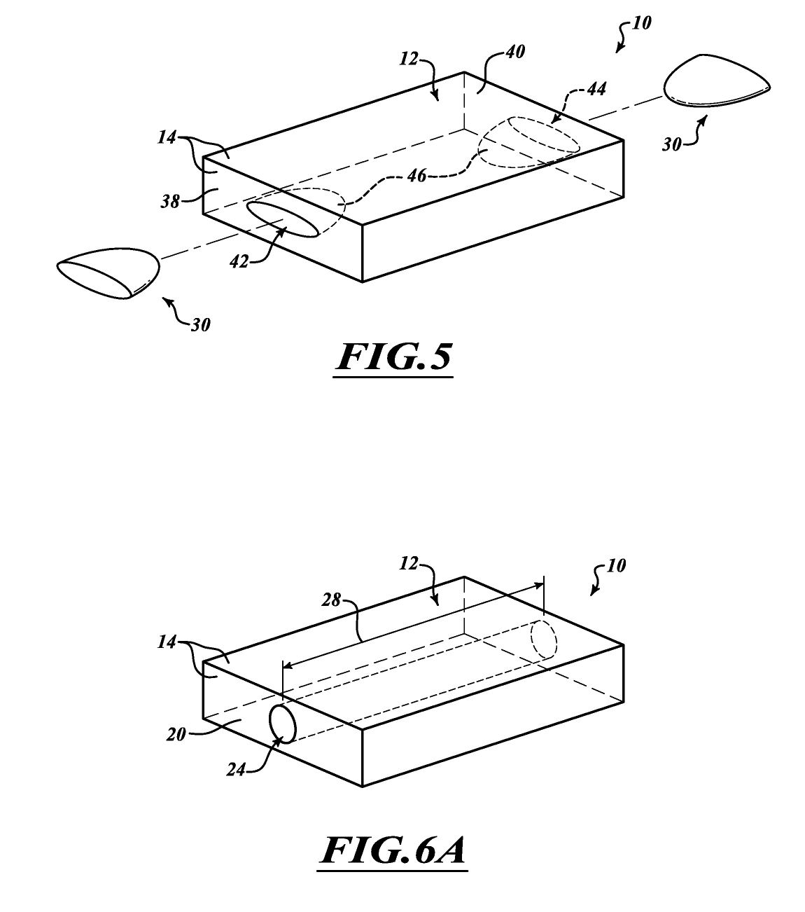

FIG. 5 shows a solid-structure consumable good 10 with a novel shape in accordance with one example embodiment. The consumable good 10 includes a pair of non-longitudinal cavities 42, 44 that intersect the exterior surface 14 of the body 12 at each end face 38, 40. Each non-longitudinal cavity 42, 44 is elliptical in shape at its intersection with its corresponding end face 38, 40 so that it approximately matches the cross-sectional area of the remnant solid-structure consumable good 30 at its thickest point. The depth of each cavity 42, 44 is half the length of the remnant solid-structure consumable good 30. An interior surface 46 of each non-longitudinal cavity 42, 44 is pocket-shaped so that each cavity contains a volume that approximately corresponds to one-half of the remnant solid-structure consumable good 30 when inserted in an appropriate orientation. In the same manner as the embodiment of FIG. 4, a remnant solid-structure consumer good 30 could be severed approximately in half and each cavity 42, 44 could receive one half of the severed good 30, except with a more snug fit between halves of the remnant solid-structure consumable good 30 and the interior of the body 12 than possible in the embodiment of FIG. 4.

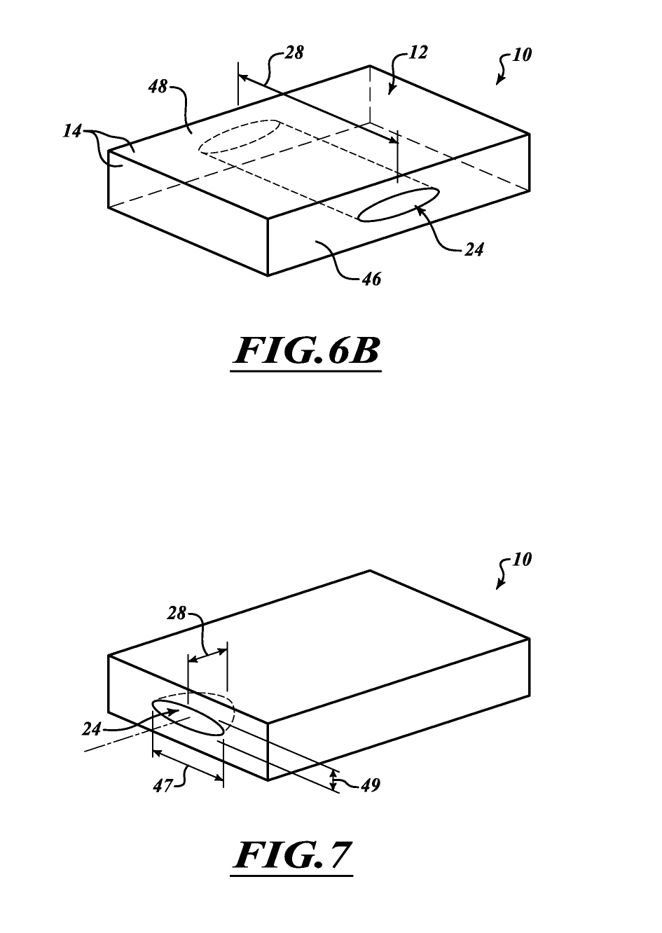

FIGS. 6(a) and 6(b) each show a solid-structure consumable good 10 with a novel shape in accordance with one example embodiment. In both figures, the longitudinal cavity 24 fully intersects the body 12 and therefore intersects the exterior surface 14 in two places. In the embodiment of FIG. 6(a), the longitudinal cavity 24 is circular in shape at its intersection with the end face 20 and maintains this shape for the entire length of the longitudinal dimension 28. In the embodiment of FIG. 6(b), the longitudinal cavity 24 intersects the body 12 from a first minor face 46 to a second minor face 48. The longitudinal cavity 24 is elliptical in shape at its intersection with the minor faces 46, 48 and maintains this shape for the entire length of the longitudinal dimension 28.

FIG. 7 shows a solid-structure consumable good 10 with a novel shape in accordance with another example embodiment. In FIG. 7, the cavity 24 has a longitudinal dimension 28 that is less than a longest lateral dimension 47 but greater than a shortest lateral dimension 49. In this embodiment the relationship between the longitudinal dimension 28 and the longest lateral dimension 47 is less than one, but between the longitudinal dimension 28 and the shortest lateral dimension 49 is greater than one. Embodiments in which the aspect ratio between the longitudinal dimension 28 and the longest lateral dimension 47 are less than one are still considered within the scope of the invention. In one example embodiment, the ratio between the longitudinal dimension 28 and the longest lateral dimension 47 is 0.2 or greater while the ratio between the longitudinal dimension 28 and the shortest lateral dimension 49 is greater than three.

The solid structure consumable goods described herein may be made using various techniques including, but not limited to, mechanically and/or manually: casting and/or using molds (e.g., making structures cast from molds or castings) and/or sculpting, drilling, digging, cutting, forging, shaping, carving, melding and/or otherwise forming the structure out of a single or multiple structures of the same consumable material and/or any other suitable processes to form the shapes and structures described herein of a solid structure consumable good. For example, molds or castings from which the solid structure(s) described herein may be cast may be reusable or disposable and have shapes such that, when used during the casting process, result in a solid structure having the shapes and/or dimensions described herein. For example, in embodiments where the solid structure consumable good is bar soap, the molds or castings from which the bar soap is cast may be made of silicone or various types of plastic, or other suitable types of materials for casting bars of soap. The structures of solid soap can be made in long bars that are cut into individual portions and/or cast from individual molds having shapes which result in the solid structures described herein when used in the bar soap casting process.

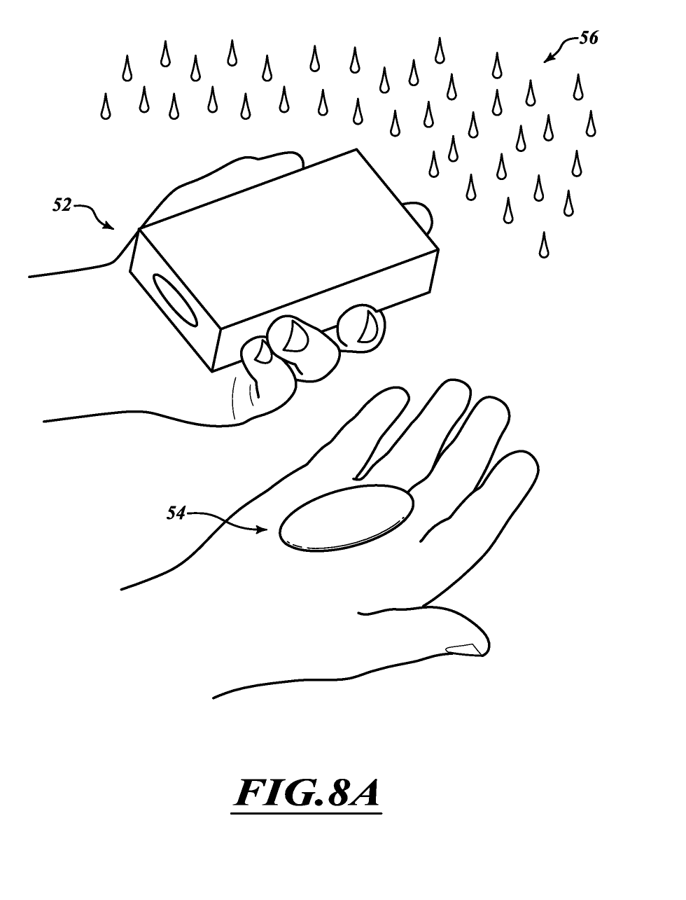

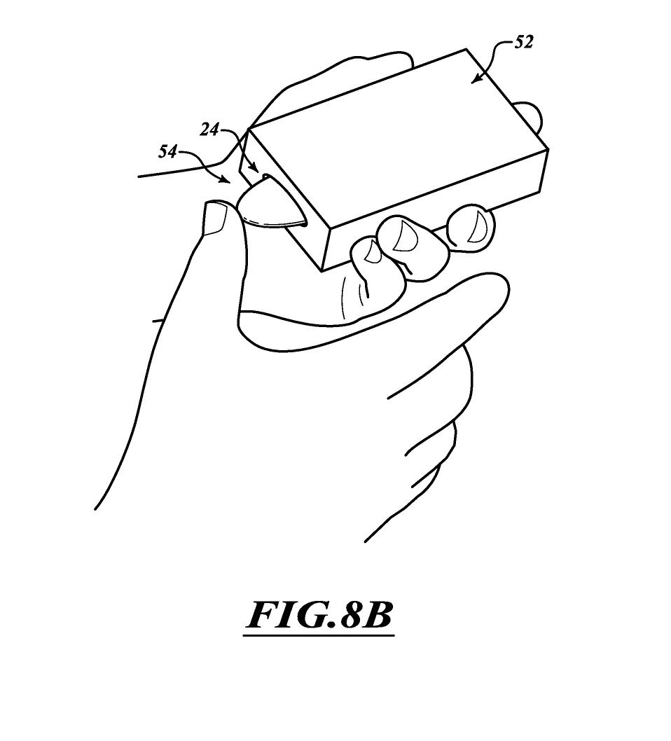

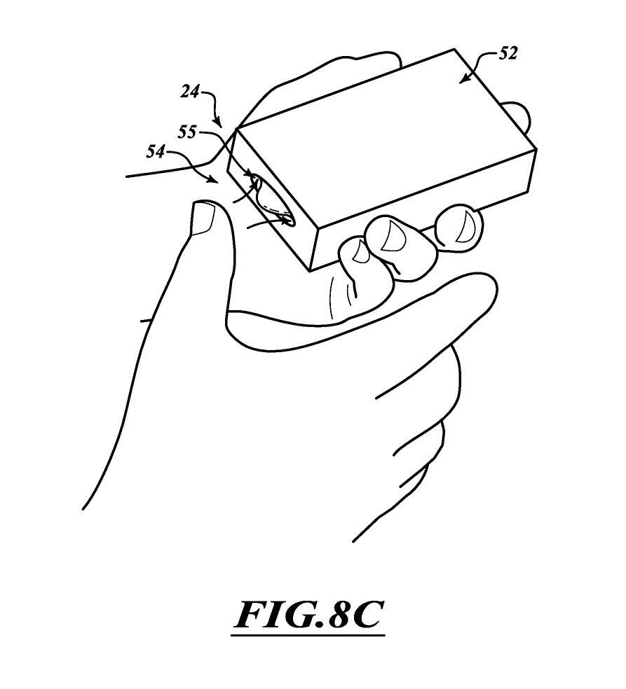

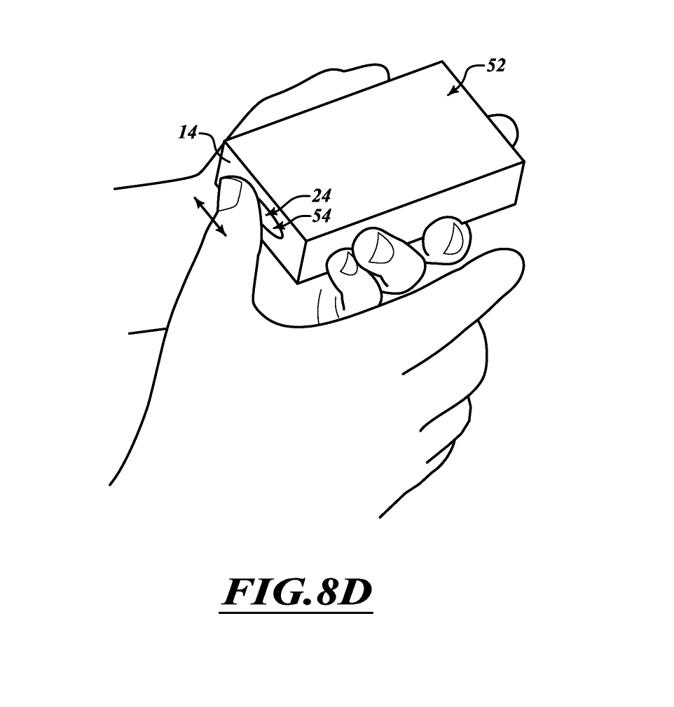

FIGS. 8A-D illustrate a method for extending the useful life of a solid-structure consumable good using structures of a solid-structure consumable good, such as, for example, the structures described herein and their equivalents, according to various embodiments.

In one step of the method (FIG. 8A), a user exposes an unused solid-structure consumable good 52 and a substantially depleted solid-structure consumable good 54 to water 56. In a second step of the method (FIG. 8B), the user holds the unused good 52 in one hand and inserts the depleted good 54 into the longitudinal cavity 24 with the other hand until the depleted good 54 is substantially within the cavity 24. In an optional third step of the method (FIG. 8C), the user deforms any portion of the depleted good 54 still extending outside the cavity 24 and pushes it into any remaining space on a cavity edge 55, if necessary. In an optional fourth step of the method (FIG. 8D), the user smears or blends onto the exterior surface 14 of the unused good 52 any portion of the depleted good 54 still extending outside the cavity 24.

In a further embodiment of the method of FIGS. 8A-D, the water 56 to which the unused solid-structure consumable good 52 and the substantially depleted solid-structure consumable good 54 are exposed is warm water. In this further embodiment, the warm water softens both the unused and the depleted solid-structure consumable goods 52, 54 so they are more deformable and each can conform to the shape of the other as the depleted good 54 is pushed into the cavity 24, especially if the cavity 24 and depleted good 54 are not substantially the same size or shape. If the depleted good 54 is more readily deformed, then the user may also more easily smear any portion of the depleted good 54 onto the unused good 52.

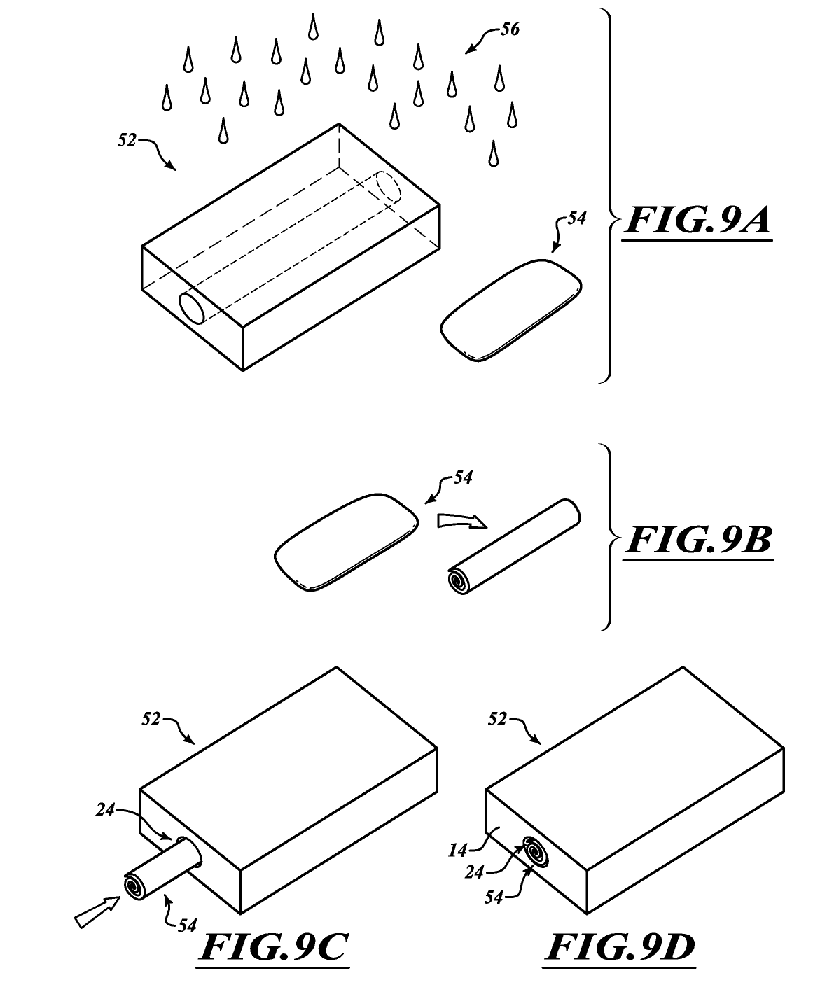

FIGS. 9A-D illustrate a method for extending the useful life of a solid-structure consumable good using structures of a solid-structure consumable good, such as, for example, the structures described herein and their equivalents, according to other various embodiments.

In one step of the method (FIG. 9A), a user exposes the unused solid-structure consumable good 52 and a substantially depleted solid-structure consumable good 54 to water 56 to soften each. In a second step (FIG. 9B), a user rolls the softened depleted good 54 into a rod shape. In a third step of the method (FIG. 9C), the user holds the unused good 52 in one hand and inserts the rod-shaped depleted good 54 into the longitudinal cavity 24 with the other hand until the depleted good 54 is substantially within the cavity 24. In an optional fourth step of the method (FIG. 9D), the user smears or blends any portion of the depleted good 54 extending outside the cavity 24 onto the exterior surface 14 of the unused good 52.

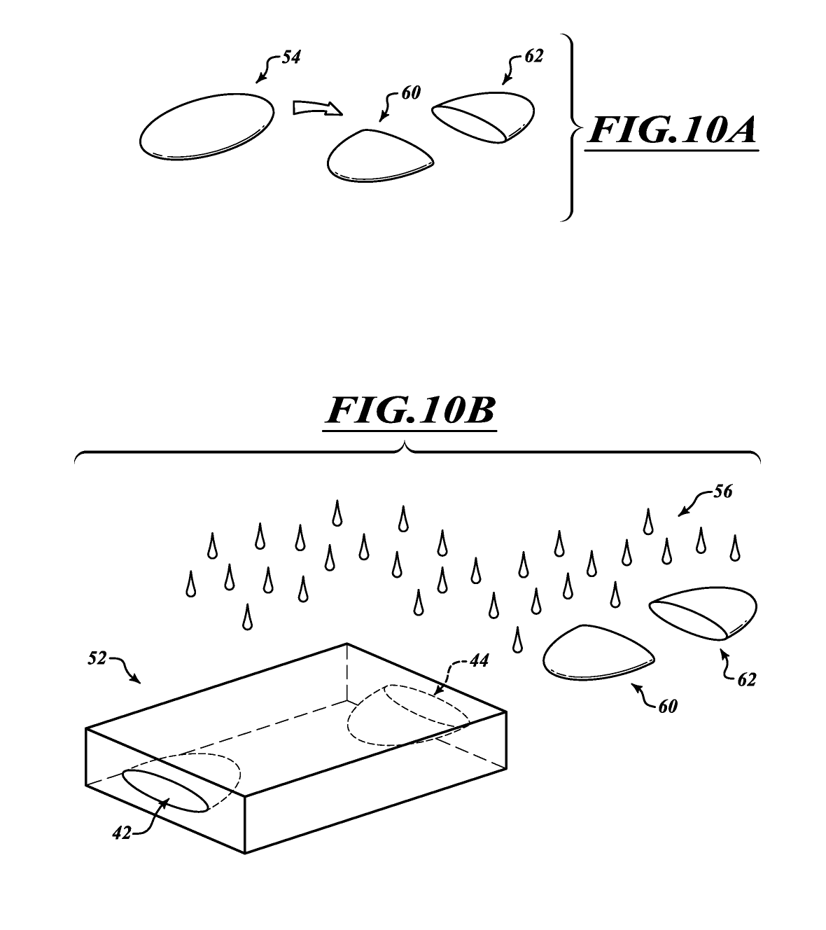

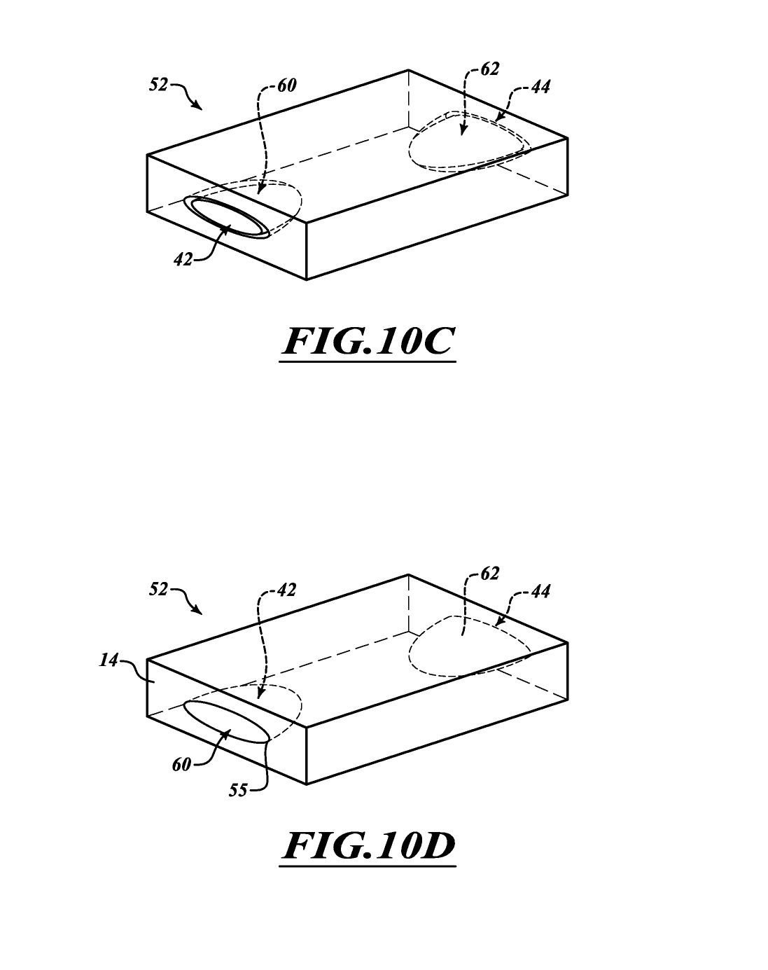

FIGS. 10A-D illustrate another method for extending the useful life of a solid-structure consumable good using structures of a solid-structure consumable good, such as, for example, the structures described herein and their equivalents, according to yet other various embodiments.

In one step of the method (FIG. 10A), a user breaks the remnant solid-structure consumable good 54 into two approximately equally sized pieces 60, 62. In a second step of the method (FIG. 10B), the user exposes the unused solid-structure consumable good 52 with non-longitudinal cavities 42, 44 and the equally sized remnant pieces 60, 62 to water 56. In a third step of the method (FIG. 10C), the user inserts one of the equally sized remnant pieces 60, 62 into one of each of the non-longitudinal cavities 42, 44 at opposite ends of the unused solid-structure consumable good 52. In an example embodiment, the size and shape of the equally sized remnants 60, 62 will approximately match the size and shape of the non-longitudinal cavities 42, 44. The better the match between the remnants and the cavities, the tighter the grip there will be between the remnants 60, 62 and the unused solid-structure consumable good 52.

In an optional fourth step of the method (FIG. 10D), the user deforms any portion of either remnant 60, 62 that still extends outside the cavities 42, 44 and pushes those portion into any remaining space on a cavity edge 55 or blends onto the exterior surface 14 of the unused good 52 any portion of either remnant 60, 62 still extending outside the cavities 42, 44.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety.

Aspects of the embodiments can be modified, if necessary to employ concepts of the various patents, application and publications to provide yet further embodiments. These and other changes can be made to the embodiments in light of the above-detailed description.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A bar of soap comprising:
a body having a solid structure; and
a first slot or pocket in the body shaped such that a remnant sliver of a substantially used bar of soap can be substantially inserted into the first slot or pocket.

2. The bar of soap of claim 1 wherein the slot or pocket in the body is shaped such that the remnant sliver becomes wedged within the bar of soap upon insertion into the slot or pocket.

3. The bar of soap of claim 1 wherein the slot or pocket is shaped to facilitate melding between the remnant sliver and the bar of soap upon insertion of the sliver.

4. The bar of soap of claim 1 wherein the slot or pocket has a shape substantially similar to a shape of the sliver to an extent such that the silver can be manually inserted into the slot or pocket and thereafter be substantially wedged within the slot or pocket without falling out during use of the bar of soap.

5. The bar of soap of claim 1 wherein the slot or pocket has a shape that is one of the following: substantially cylindrical, substantially of an elliptical cylinder, substantially of a prism, substantially of a triangular prism, substantially of a rectangular prism, substantially of a section of a tri-axial ellipsoid defined by a cross-section of the tri-axial ellipsoid, substantially of a section of a tri-axial ellipsoid defined by a bisection of the tri-axial ellipsoid substantially along an axis of the tri-axial ellipsoid.

6. The bar of soap of claim 5 wherein the tri-axial ellipsoid is substantially the shape and size of the sliver.

7. The bar of soap of claim 1 wherein the ratio of the slot or pocket's depth to its narrowest breadth is greater than 0.2.

8. The bar of soap of claim 1 wherein the ratio of the slot or pocket's depth to its narrowest breadth is greater than 1.0.

9. The bar of soap of claim 1 wherein the slot or pocket extends all the way through the body.

10. The bar soap of claim 1 wherein the slot or pocket has traction features formed on at least a portion of an interior surface of the slot or pocket.

11. The bar soap of claim 1 wherein the slot or pocket has ridges along at least a portion of an interior surface of the slot or pocket.

12. The bar soap of claim 11 wherein the ridges run at least one of: lengthwise along the slot or pocket, diagonally along the interior surface of the slot or pocket, and widthwise along the interior surface of the slot or pocket.

13. The bar of soap of claim 1 further comprising a second slot or pocket in the body shaped such that portions of the remnant sliver of a substantially used bar of soap can be substantially inserted into each of the first and second slot or pocket.

14. The bar of soap of claim 13 wherein the first and second slots or pockets are at opposite ends of the bar of soap.

15. The of bar soap of claim 13 wherein the first slot or pocket has a shape substantially similar to a shape of a first portion of the sliver and wherein the second slot or pocket has a shape substantially similar to a shape of a second portion of the sliver.

16. The bar of soap of claim 13 wherein the first and second slots or pockets each have a shape that is one of the following: substantially cylindrical, substantially of an elliptical cylinder, substantially of a prism, substantially of a triangular prism, substantially of a rectangular prism, substantially of a section of a tri-axial ellipsoid defined by a cross-section of the tri-axial ellipsoid, substantially of a section of a tri-axial ellipsoid defined by a bisection of the tri-axial ellipsoid substantially along an axis of the tri-axial ellipsoid.

17. The bar of soap of claim 16 wherein the tri-axial ellipsoid is substantially the shape and size of half of the sliver.

18. The bar soap of claims 1 wherein the bar has at least one of: a curved shape, one or more curved surfaces, a shape substantially of a prism, a shape substantially of a polyhedron.

19. A method for extending the useful life of a bar of soap comprising:
exposing at least one of an unused bar of soap and a remnant sliver of a substantially used bar of soap to water; and
inserting the remnant sliver into a slot or pocket in the unused bar.

20. The method of claim 19 further comprising deforming a portion of the remnant sliver that extends outside the slot or pocket, such that the deformed portion of the remnant sliver fills an unoccupied space within the slot or pocket of the unused bar.

21. The method of claim 19 further comprising smearing onto a surface of the unused bar a portion of the remnant sliver that extends outside the slot or pocket, such that the extended portion of the remnant sliver becomes more flush with the surface of the unused bar.

22. The method of claim 19 further comprising first separating the remnant sliver into halves and inserting each remnant half into a separate slot or pocket in the unused bar.
